(19) United States
(12) Patent Application Publication
(10) Pub. No.: US 2009/0095323 A1
(43) Pub. Date: Apr. 16, 2009

(54) Valve with sensor for process solution, and apparatus and method for treating substrate using the same

(76) Inventors: Hye-Son Jung, Gyeonggi-do (KR); Young-Ho Choo, Chungcheongnam-do (KR)

Correspondence Address: JENKINS, WILSON, TAYLOR & HUNT, P. A., Suite 1200 UNIVERSITY TOWER, 3100 TOWER BLVD.,, DURHAM, NC, 27707, US

(21) Appl. No.: 12/287,567

(22) Filed: Oct. 10, 2008

(30) Foreign Application Priority Data
Oct. 12, 2007 (KR) 2007-102975

(51) Int. Cl. B08B 3/04; F16K 21/18

(52) U.S. Cl. 134/18; 134/113; 134/57 R; 137/391

(57) ABSTRACT

Provided is a valve with a sensor for process solution, a substrate treating apparatus employing the valve, and a substrate treating method. The valve includes a body, an inlet, an outlet, a shutter, and a sensor. The body is provided with a passage within, through which a process solution for a substrate flows. The inlet is connected to one end of the passage, through which the process solution flows into the body. The outlet is connected to another end of the passage, through which the process solution is discharged to an outside of the body. The shutter is for opening or closing the passage at a region where the inlet and the passage are connected. The sensor is coupled to the body to contact the process solution flowing through the passage and sense a composition of the process solution.

### CROSS-REFERENCE TO RELATED APPLICATION

This U.S. non-provisional patent application claims priority under 35 U.S.C. §119 of Korean Patent Application No. 10-2007-0102975, filed on Oct. 12, 2007, the entire contents of which are hereby incorporated by reference.

### BACKGROUND

The present invention disclosed herein relates to valve with a sensor for process solution and to an apparatus and method for treating a substrate using the same, and more particularly, to a valve with a sensor for process solution and to an apparatus and method for treating a substrate using the same that are capable of increasing product life and improving process efficiency.

Electronic devices such as a semiconductor memory device or a flat panel display device include a substrate. The substrate may be a silicon wafer or a glass substrate. A plurality of conductive layer patterns is formed on the substrate, and a dielectric pattern for insulation is formed between each of the plurality of conductive layer patterns. The conductive layer patterns or the dielectric patterns are formed through performing a sequence of processes such as exposing, developing, etching, and cleaning.

A portion of the processing involves using a processing bath filled with a process solution. The processing bath may be provided in plurality according to the processing required. The plurality of processing baths may be filled with the same process solution for performing the same process, or may be filled with different process solutions for performing different processes. Also, the processing baths may include a processing bath filled with cleaning solution for cleaning a substrate after the substrate has been processed.

When a cleaning solution is used as a process solution to clean a substrate, the point at which cleaning is completed is determined to end the cleaning process. To determine the point of completion, a sensor that contacts the process solution may be used, and the sensor is exposed to the cleaning solution. However, acidic ingredients may be included in the cleaning solution, so that the sensor can be damaged from prolonged exposure to the acidic ingredients, reducing its service life.

### SUMMARY

The present invention provides a valve with a sensor for a process solution that has an extended product life and which increases process efficiency.

The present invention also provides a substrate treating apparatus employing a valve.

The present invention further provides a method for treating a substrate that can be applied to the above substrate treating apparatus.

Embodiments include valves with a sensor for process solution. The valve includes a body, an inlet, an outlet, a shutter, and a sensor. The body is provided with a passage within, through which a process solution for a substrate flows. The inlet is connected to one end of the passage, through which the process solution flows into the body. The outlet is connected to another end of the passage, through which the process solution is discharged to an outside of the body. The shutter is for opening or closing the passage at a region where the inlet and the passage are connected. The sensor is coupled to the body to contact the process solution flowing through the passage and sense a composition of the process solution.

In some embodiments, the sensor may measure a specific resistance of the process solution.

In other embodiments, the process solution may include pure water. Here, the sensor may sense a concentration of hydrofluoric acid included in the pure water.

In other embodiments, substrate treating apparatuses include a processing bath, a first discharge line, and a first valve. The processing bath is provided with a process solution, for treating a substrate with the process solution. The first discharge line is connected to the processing bath, discharging the process solution. The first valve is installed in the first discharge line. The first valve includes a body, an inlet, an outlet, a shutter, and a sensor. The body is provided with a passage within, through which the process solution flows. The inlet is connected to one end of the passage, through which the process solution flows into the body. The outlet is connected to another end of the passage, through which the process solution is discharged to an outside of the body. The shutter is for opening or closing the passage at a region where the inlet and the passage are connected. The sensor is coupled to the body to contact the process solution flowing through the passage and sense a composition of the process solution.

In some embodiments, the substrate treating apparatus may further include a controller connected to the sensor to control an ending of the treating according to a sensed result.

In other embodiments, the substrate treating apparatus may further include a second discharge line connected to the processing bath to discharge the process solution, and to which the first discharge line is coupled. Here, the process bath may include an inner bath receiving the process solution and in which the substrate is immersed in the received process solution, and an outer bath surrounding the inner bath to receive the process solution that overflows from the inner bath. In this case, the first discharge line may be connected to the outer bath, and the second discharge line may be connected to the inner bath. Here, the substrate treating apparatus may further include a third discharge line connected to the outer bath to discharge the process solution, and coupled to the second discharge line.

In still other embodiments, methods for treating a substrate include performing a treating of a substrate in a processing bath provided with a process solution, opening a passage of a discharge line connected to the processing bath, sensing a composition of the process solution discharged through the discharge line, and ending the treating according to a result of the sensing, wherein the opening the passage and the sensing the composition are performed at the same location.

In some embodiments, the treating may be a cleaning process of the substrate, and the process solution may include pure water. Here, the sensing of the composition may include measuring the specific resistance of the process solution, and ending the treating when the specific resistance is greater than a reference value.

In other embodiments, the sensing of the composition may include measuring a specific resistance of the process solution, sensing a concentration of hydrofluoric acid included in the pure water, and ending the treating when the measured specific resistance exceeds a reference value.

### BRIEF DESCRIPTION OF THE FIGURES

The accompanying figures are included to provide a further understanding of inventive concept, and are incorporated in and constitute a part of this specification. The drawings illustrate exemplary embodiments of the inventive concept and, together with the description, serve to explain principles of the inventive concept. In the figures:

FIG. 1 is a sectional view of a valve according to embodiments;

FIG. 2 is a perspective view of a substrate treating apparatus according to embodiments;

FIG. 3 is a configurative view of a sub processing unit illustrated in FIG. 1;

FIGS. 4A and 4B are diagrams illustrating a processing procedure with the sub processing unit in FIG. 3;

FIG. 5 is a configurative view of a sub processing unit in FIG. 1 according to other embodiments;

FIGS. 6A and 6B are diagrams illustrating a processing procedure with the sub processing unit in FIG. 5; and

FIG. 7 is a flowchart of a substrate treating method according to embodiments.

### DETAILED DESCRIPTION OF PREFERRED EMBODIMENTS

Preferred embodiments will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

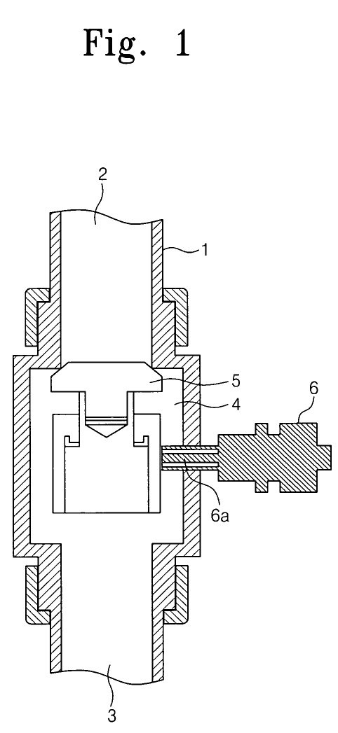

FIG. 1 is a sectional view of a valve according to embodiments.

Referring to FIG. 1, the valve may include a body 1, an inlet 2, an outlet 3, a passage 4, a shutter 5, and a sensor 6. The body 1 is configured to define a hollow space within along its length. The inlet 2 is defined in one end of the body 1 along the length thereof, and the outlet 3 is defined in the opposite end. The passage 4 is defined in the body 1 through the hollow configuration thereof, and the passage 4 communicates the inlet 2 and the outlet 3. The body 1 has the shutter 5 installed for opening and closing the inlet 2 communicating with the passage 4. The shutter 5 rises and descends along the length of the body 1, and seals the inlet 2 by moving upward. The shutter 5 opens the inlet 2 by moving downward, in which case, the passage 4 is defined from the inlet 2 along the perimeter surrounding the shutter 5. The sensor 6 is coupled to the body 1, and its end portion 6a is passed through the body 1 and inserted in the passage 4.

Such a valve is installed in a passage through which many types of fluids flow, to control the flow of the fluids. Fluid enters through the inlet 2, and passes through the passage 4 and flows out through the outlet 3 when the shutter 5 opens the passage. While passing through the passage 4, fluid passes by the end portion 6a of the sensor 6. The sensor 6 contacts the fluid at the end portion 6a and senses the composition of the fluid. Any of various methods for sensing the composition of the fluid may be employed. For example, when the fluid includes acidic components, the sensor may measure the pH level of the fluid, or may measure the quantity of ions dissociated from the acidic components according to changes in the conductivity or resistivity of the fluid to determine the conductivity or resistivity. Also, the concentration or number of particles of a certain component of the fluid may be measured.

The fluid may be any of various fluids according to the type of apparatus the valve is employed in. For example, when the valve is used in a treating apparatus for manufacturing semiconductor substrates, the fluid may be a process solution used in semiconductor substrate manufacturing. The process solution may be hydrofluoric acid, sulfuric acid, phosphoric acid, or ultrapure water.

When the valve is provided with a substrate treating apparatus, the valve controls flow of the process solution and the sensor 6 coupled to the valve senses the composition of the process solution. Therefore processing states may be grasped, a suitable management to the processing states may be chosen. Also, because the sensor 6 is coupled and integrally formed with the valve the sensor 6, the sensor 6 is installed to the substrate treating apparatus easily, additional equipment is unnecessary and cost effectiveness can be realized.

The configuration illustrated in FIG. 1 is an embodiment provided as an example, and may have various different configurations of a sensor coupled to a valve other than the above embodied valve. Below, several exemplary embodiments of a substrate processing apparatus will be described.

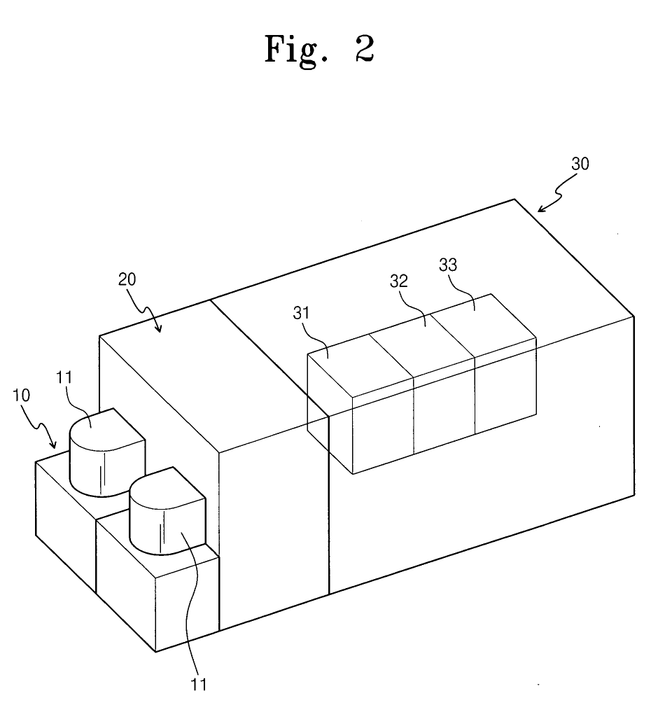

FIG. 2 is a perspective view of a substrate treating apparatus according to embodiments.

Referring to FIG. 2, a substrate treating apparatus may include a load port 10, a transfer unit 20, and a processing unit 30. Substrates such as semiconductor wafers are loaded and unloaded at the load port 10. Wafers at the load port 10 are loaded in plurality in a cassette 11 to be simultaneously processed. The transfer unit 20 receives wafers from the load port 10 and transfers them to the processing unit 30. The transfer unit 20 has a transfer robot (not shown) disposed at the lower portion of the transfer unit 20 for transferring wafers.

The processing unit 30 processes wafers transferred from the transfer unit 20. The processing unit 30 includes a plurality of sub processing units. That is, the processing unit 30 includes a first sub processing unit 3 1, a second sub processing unit 32 and a third sub processing unit 33. The processing unit 30 may include further sub processing units in addition to the first through third sub processing units 31, 32 and 33. Also, the processing unit 30 may not have a portion of the first through third sub processing units 31, 32 and 33, depending on requirements.

The first through third sub processing units 31, 32 and 33 include processing baths in which process solution for performing various processes to the wafers is filled. For example, the processing may include etching, cleaning, and drying. The etching, cleaning, and drying processes may employ various process solutions including hydrofluoric acid, sulfuric acid, deionized water, isopropyl alcohol, etc.

The process solutions filled in the processing baths of the respective first through third sub processing units 31, 32 and 33 may be the same process solution for performing the same processing. Alternatively, the process solution filled in the processing baths of the respective first through third sub processing units 31, 32 and 33 may be process solutions having respectively different ingredients. Also, the process solution filled in the process baths of the respective first through third sub processing units 31, 32 and 33 may be respectively different process solutions for performing different processes.

Below, the configuration of one of the first through third sub processing units 31, 32 and 33 will be described. The below sub processing unit configuration may be the same as the configurations of all of the first through third sub processing units 31, 32 and 33, or may be different from a portion thereof. However, even when there are different configurations, the basic configurations will generally not deviate much from the configuration below.

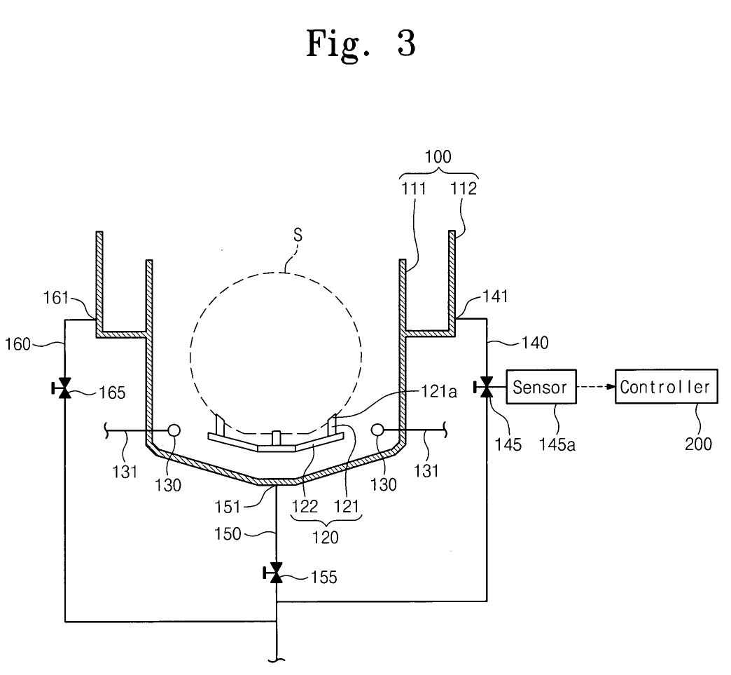

FIG. 3 is a configurative view of a sub processing unit illustrated in FIG. 1.

Referring to FIG. 3, a sub processing unit may include a processing bath 100, a support 120, a discharge nozzle 130, discharge lines 140, 150, and 160, and a controller 200. The processing bath 100 has a space in which process solution is held, to perform processing of a substrate (S) such as a semiconductor wafer inside the space.

Specifically, the processing bath 100 includes an inner bath 111 and an outer bath 112. The inner bath 111 has an open top, and the outer bath 112 encloses the outer periphery of the inner bath 111. The inner bath 111 holds a process solution required in processing a semiconductor substrate (S), and the outer bath 112 holds process solution that overflows from the inner bath 111.

The support 120 for supporting the substrate (S) during processing is installed within the inner bath 111. The support 120 includes a plurality of supporting rods 121 disposed in parallel to one another, and a coupling plate 122 connecting the supporting rods 121. Each supporting rod 121 defines a slot 121a in a longitudinal end thereof, in which a portion of the edge of a substrate (S) is inserted. There are about 50 slots 121a formed, so that the support 120 can simultaneously support a maximum of 50 wafers (W).

The inner bath 111 has the discharge nozzle 130 installed therein. The discharge nozzle 130 is connected to the supply line 131, and the supply line 131 is connected to an external process solution source. Accordingly, the process solution is transferred from the source through the supply line 131 and discharged from the discharge nozzle 130 into the inner bath 111. The supply line 131 may be connected to one source that supplies one type of process solution. Also, the supply line 131 may be connected to a plurality of sources that supplies a plurality of types of process solution. When a plurality of sources is connected, the supply line 131 may be branched to the plurality of sources, where one or a plurality of types of sources may be simultaneously or sequentially provided through each branched line for each stage of processing.

The processing bath 100 defines first through third outlets 141, 151 and 161, and the first through third outlets 141, 151 and 161 are connected to the first through third discharge lines 140, 150 and 160, respectively. The first outlet 141 is defined in the outside in the outer bath 112, and a first valve 145 is installed in the first discharge line 140. The second outlet 151 is defined in the inner bath 111, and a second valve 155 is installed in the second discharge line 150. The third outlet 161 is defined in the outer bath 112, and a third valve 165 is installed in the third discharge line 160. The first and second discharge lines 140 and 160 converge with the second discharge line 150. Thus, the process solution is discharged to the outside through the second discharge line 150 that is ultimately converged. However, the first and third discharge lines 140 and 160 do not necessarily have to converge with the second discharge line 150, and the first through third discharge lines 140, 150 and 160 may be independent to separately discharge the process solution.

The first valve 145 has a sensor 145a, for sensing the composition of the process solution, coupled thereto. The first valve 145 may be a valve used in the above described embodiments. The controller 200 controls operation of the processing apparatus according to the sensed results by the sensor 145a.

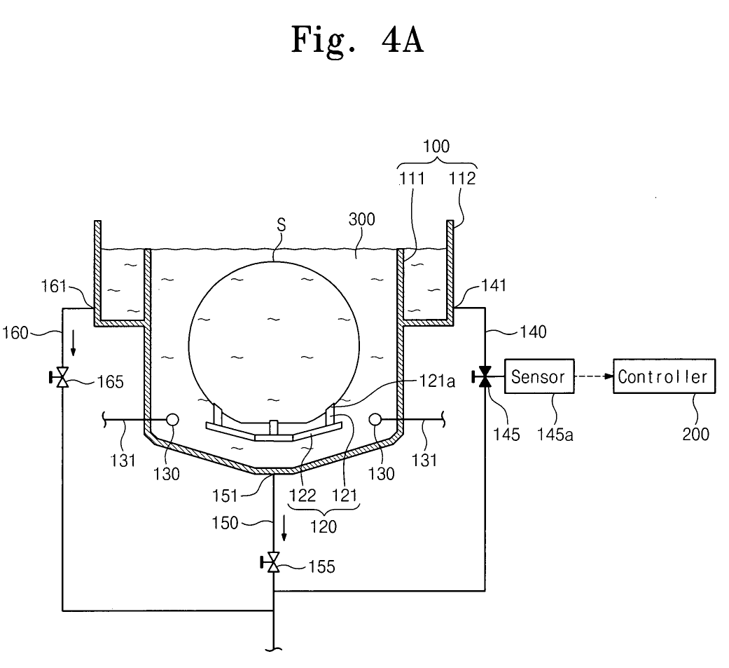

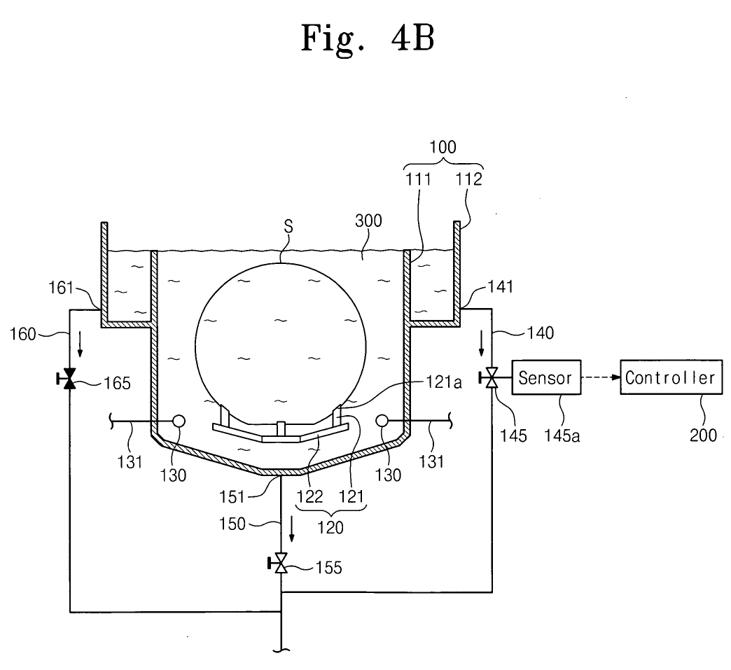

FIGS. 4A and 4B are diagrams illustrating a processing procedure with the sub processing unit in FIG. 3.

Referring to FIG. 4A, process solution 300 is filled inside the inner bath 111, and process solution 300 that overflows from the inner bath 111 fills the outer bath 112. A substrate (S) is introduced into the inner bath 111 and supported by the support 120. While the substrate (S) is supported by the support 120, the substrate (S) is immersed in the process solution 300 and processing is performed in which reaction occurs with the process solution 300. For example, when the processing is a cleaning process of the substrate (S), chemicals are supplied to the processing bath 100 to remove various foreign substances and impurities. Then, pure water is supplied to the substrate (S), so that the pure water rinses the substrate (S) and removes the chemicals from the substrate (S).

When the above processing is performed, the second and third valves 155 and 165 (and not the first valve 145) are opened to open the second and third discharge lines 150 and 160. Accordingly, the process solution 300 is discharged through the second discharge line 150 from the inner bath 111, and the process solution 300 that has overflowed is discharged through the third discharge line 160 from the inner bath 111.

Referring to FIG. 4B, after a predetermined time elapses from the time the rinse process with the pure water is performed, the first valve 145 is opened. Thus, the first discharge line 140 is opened, and the process solution 300 is discharged through the first discharge line 140. Because the process solution 300 is discharged from the outer bath 112, while the first discharge line 140 is open, it does not matter whether the third discharge line 160 (that is another discharge path from the outer bath) is opened or sealed. However, in the present embodiment, when the first discharge line 140 is opened, the third discharge line 160 is sealed.

The process solution 300 that passes through the first discharge line 140 passes through the first valve 145, whereupon its ingredients are analyzed and sensed by the sensor 145a. In the sensing stage, the quantity of chemicals included in pure water used as the process solution 300 is analyzed. If the analysis results indicate that the quantity of chemicals is less than (or the same as or lower than) a reference value, it is determined that sufficient rinsing has been performed, and the processing is ended. If the analysis results indicate that the quantity of chemicals is the same or higher than (or exceeds) a reference value, it is determined that insufficient rinsing has been performed, and the rinsing process is continued.

As described above, the sensor 145a may analyze the quantity of chemicals through various methods. For example, when the chemical is hydrofluoric acid, hydrofluoric acid is an acidic process solution that is dissociated to ions, and conductivity is increased by an increase in ion quantity. Accordingly, specific resistance decreases when the quantity of chemicals in pure water is large, and conversely, specific resistance increases when the quantity of chemicals in pure water is small. When the specific resistance value is measured and found to be greater than a reference specific resistance value, it is determined that sufficient rinsing has been performed to remove the chemicals, and the processing is ended.

However, because chemicals such as hydrofluoric acid have the property of corroding glass or quartz, when the sensor 145a is continually exposed and put in contact with such chemicals, it can be damaged, thus reducing the service life of the product. Accordingly, the sensor 145a may be contacted with chemicals for minimal amounts of time needed to perform analyses.

According to the present embodiment, process solution discharged from the outer bath 112 is mostly discharged through the third discharge line 160, and the first discharge line 140 in which the sensor 145a is installed is opened only for sensing the chemicals. Thus, the time that the sensor 145a contacts the chemicals is minimized, so that damage to the sensor 145a can be prevented and service life can be extended. Also, because the sensor 145a is coupled and integrally formed with the first valve 145, its installation is made easier, additional equipment is unnecessary, and cost effectiveness can be realized.

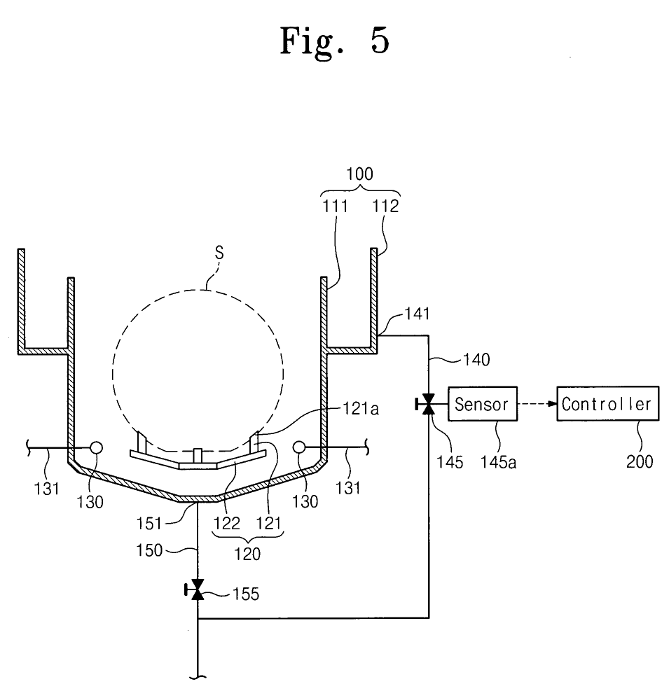

FIG. 5 is a configurative view of a sub processing unit in FIG. 1 according to other embodiments of the present invention. In present embodiments, like reference numerals are used for like elements in the above embodiments, and repetitive detailed description of such elements will not be provided.

Referring to FIG. 5, a sub processing unit includes a processing bath 100, a support 120, a discharge nozzle 130, discharge lines 140 and 150, and a controller 200. The processing bath 100 includes an inner bath 111 and an outer bath 112. The inner bath 111 has the support 120 installed within to support a substrate (S). Also, the inner bath 111 has the discharge nozzle 130 installed. The discharge nozzle 130 is connected to a supply line 131 that receives process solution for a substrate (S) from an external source.

The processing bath 100 defines a first and second outlet 141 and 151, and first and second discharge lines 140 and 150 are connected to the first and second outlets 141 and 151, respectively. The first outlet 141 is defined in the outer bath 112, and a first valve 145 is installed in the first discharge line 140. The second outlet 151 is defined in the inner bath 111, and a second valve 155 is installed in the second line 150. The first discharge line 140 converges with the second discharge line 150.

The first valve 145 has a sensor 145a, for analyzing and sensing the process solution, coupled thereto, and the controller 200 is connected to the sensor 145a. The controller 200 controls the operation of the substrate processing apparatus according to sensing results from the sensor 145a.

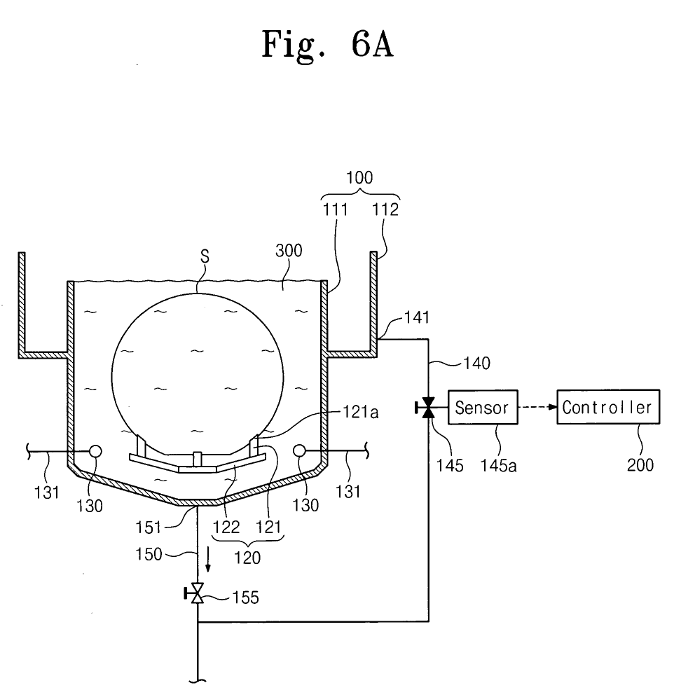

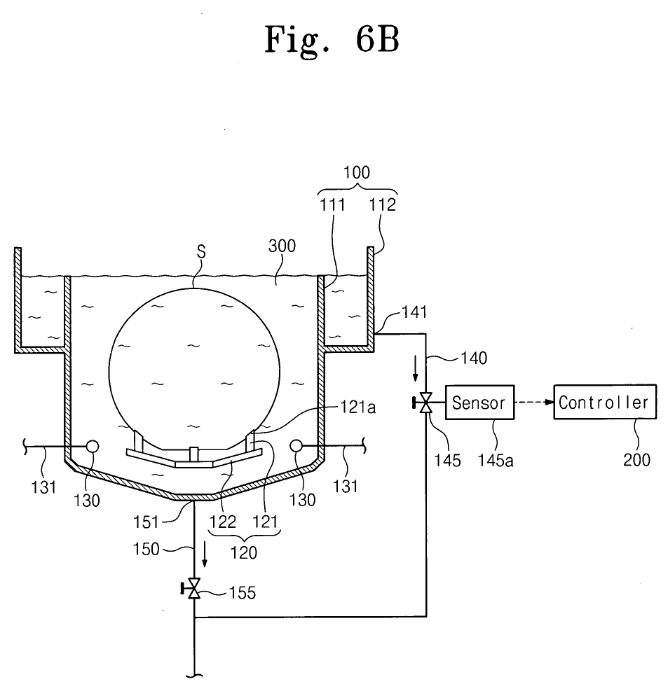

FIGS. 6A and 6B are diagrams illustrating a processing procedure with the sub processing unit in FIG. 5.

Referring to FIG. 6A, process solution 300 is filled in the inner bath 111. The process solution 300 is supplied to fill only the inner bath 111 and not overflow from the inner bath 111. The substrate (S) is mounted on the support 120, and is immersed in the process solution 300 to perform processing. For example, if the processing is a cleaning process of a substrate (S), chemicals are supplied to the processing bath 100 to remove various foreign substances or impurities from the substrate (S). Then, pure water is supplied to the substrate (S), whereupon the pure water rinses the substrate (S) and removes the chemicals from the substrate (S). While the processing is performed, the second valve 155 is opened to open the second discharge line 150 and discharge the process solution 300 from the inner bath 111 through the second line 150.

Referring to FIG. 6B, after the rinsing with the pure water is performed for a predetermined duration, the process solution 300 overflows from the inner bath 111 to the outer bath 112. Also, the first valve 145 is opened to open the first discharge line 140, and the process solution is discharged through the first discharge line 140.

In the first discharge line 140, process solution 300 passes the first valve 145 and is analyzed in terms of its constituents by the sensor 145a. According to the sensed results, when it is determined that sufficient rinsing has been performed, the controller 200 ends the cleaning process. If the sensed results indicate that insufficient rinsing has been performed, the controller 200 continues performing the cleaning process.

Unlike in above embodiments, in the present embodiment, only the first discharge line 140 is formed as a discharge passage for the outer bath 112. Thus, while processing is being performed, when process solution 300 overflows from the inner bath 111 to the outer bath 112, the overflowed process solution 300 must be discharged through the first discharge line 140. In this case, the sensor 145a is continuously exposed to the process solution 300, and the sensor 145a is prone to damage and a shortened service life if the process solution 300 includes chemicals such as hydrofluoric acid. In consideration of the latter, if a separate discharge line from the outer bath 112 is not installed in addition to the first discharge line 140 with the sensor 145a installed, the process solution 300 is made to overflow to the outer bath 112 while analysis of its components is being performed. Accordingly, the time that the sensor 145a contacts the chemicals is minimized, thus preventing damage to the sensor 145a and extending its service life. Also, because the sensor 145a is coupled to and integrally formed with the first valve 145, and a discharge line is singularly installed from the outer bath 112, installation is made easy, additional equipment is unnecessary, and cost-effectiveness is attained.

Below a description will be given of a substrate treating method that can be applied to the apparatus according to the above embodiments. The method described below will use reference numerals used in the above embodiments in order to be applicable to the apparatus according to the above embodiments, and for the sake of descriptive convenience. However, it will be understood that the below method for treating a substrate will not be limited in application to only the apparatus described in embodiments above, and may be applied to a variety of similar apparatuses.

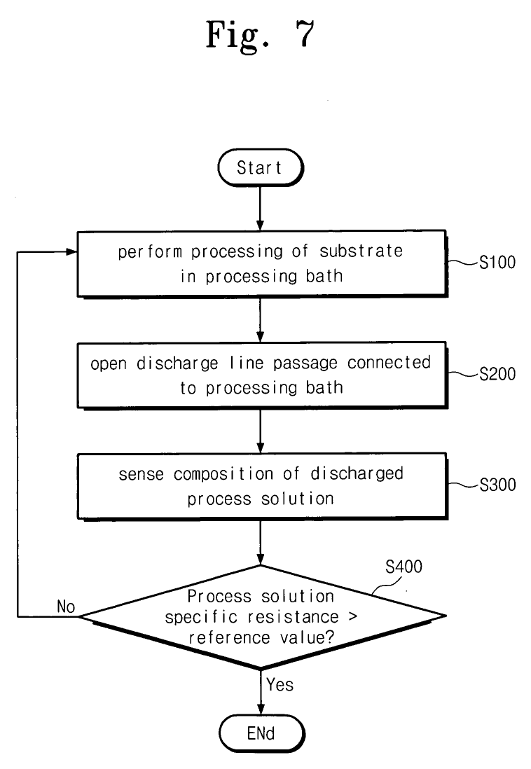

FIG. 7 is a flowchart of a substrate treating method according to embodiments of the present invention.

Referring to FIG. 7, a treating of a substrate (S) in a processing bath 100 is performed in a first operation (S100). The treating may include various processes such as cleaning or etching, and is performed by filling a process solution 300 corresponding to each process in the processing bath 100, and immersing the substrate (S) inside the processing bath 100.

In a second operation (S200), passages for discharge lines 140, 150, and 160 connected to the processing bath 100 are opened. Accordingly, process solution 300 is discharged from the processing bath 100 through the discharge lines 140, 150, and 160.

In a third operation (S300), the composition of the discharged process solution 300 is analyzed. In this process, when chemicals including hydrofluoric acid are used to clean the substrate (S) and pure water is used to rinse the substrate (S), the quantity of hydrofluoric acid remaining in the pure water is sensed. The quantity of hydrofluoric acid is sensed by measuring the specific resistance of the process solution 300, and the sensor 145a sensing the quantity of hydrofluoric acid is coupled to a valve 145 that opens the passage of the corresponding discharge line 140. Thus, the opening of the passage in the corresponding discharge line 140 and the analyzing of the components are performed in the same location.

In a fourth operation (S400), the measured specific resistance value is compared to a reference value. If the measured value is less than the reference value, additional rinsing is performed, and if the measured value is greater than the reference value, processing is ended.

According to embodiments of the present invention, contact between a process solution and a sensor is minimized to extend product life and improve process efficiency.

As described above, according to present embodiments, product service life can be extended, and process efficiency can be improved. However, the above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A valve comprising:
a body provided with a passage within, through which a process solution for a substrate flows;
an inlet connected to one end of the passage, through which the process solution flows into the body;
an outlet connected to another end of the passage, through which the process solution is discharged to an outside of the body;
a shutter opening or closing the passage at a region where the inlet and the passage are connected; and
a sensor coupled to the body to contact the process solution flowing through the passage and sense a composition of the process solution.

2. The valve of claim 1, wherein the sensor measures a specific resistance of the process solution.

3. The valve of claim 1, wherein the process solution comprises pure water.

4. The valve of claim 3, wherein the sensor senses a concentration of hydrofluoric acid included in the pure water.

5. The valve of claim 1, wherein the sensor comprises one end passed through the body to contact the process solution flowing through the passage.

6. A substrate treating apparatus comprising:
a processing bath provided with a process solution, treating a substrate with the process solution;
a first discharge line connected to the processing bath, discharging the process solution; and
a first valve installed in the first discharge line, the first valve comprising:
a body provided with a passage within, through which the process solution flows;
an inlet connected to one end of the passage, through which the process solution flows into the body;
an outlet connected to another end of the passage, through which the process solution is discharged to an outside of the body;
a shutter opening or closing the passage at a region where the inlet and the passage are connected; and
a sensor coupled to the body to contact the process solution flowing through the passage and sense a composition of the process solution.

7. The substrate treating apparatus of claim 6, wherein the sensor measures a specific resistance of the process solution.

8. The substrate treating apparatus of claim 6, wherein the process solution comprises pure water.

9. The substrate treating apparatus of claim 8, wherein the sensor senses a concentration of hydrofluoric acid included in the pure water.

10. The substrate treating apparatus of claim 6, wherein the sensor comprises one end passed through the body to contact the process solution flowing through the passage.

11. The substrate treating apparatus of claim 6, further comprising a controller connected to the sensor to control an ending of the treating according to a sensed result.

12. The substrate treating apparatus of claim 6, further comprising a second discharge line connected to the processing bath to discharge the process solution, and to which the first discharge line is coupled.

13. The substrate treating apparatus of claim 12, wherein the process bath comprises:
an inner bath receiving the process solution and in which the substrate is immersed in the received process solution; and
an outer bath surrounding the inner bath to receive the process solution that overflows from the inner bath.

14. The substrate treating apparatus of claim 13, wherein the first discharge line is connected to the outer bath and the second discharge line is connected to the inner bath.

15. The substrate treating apparatus of claim 14, further comprising a third discharge line connected to the outer bath to discharge the process solution, and coupled to the second discharge line.

16. A method for treating a substrate, comprising:
performing a treating of a substrate in a processing bath provided with a process solution;
opening a passage of a discharge line connected to the processing bath;
sensing a composition of the process solution discharged through the discharge line; and
ending the treating according to a result of the sensing,
wherein the opening the passage and the sensing the composition are performed at the same location.

17. The method of claim 16, wherein the treating is a cleaning process of the substrate, and the process solution comprises pure water.

18. The method of claim 17, wherein the sensing the composition comprises measuring a specific resistance of the process solution.

19. The method of claim 18, wherein the sensing the composition comprises sensing a concentration of hydrofluoric acid included in the pure water, in addition to the measuring of the specific resistance.

20. The method of claim 19, wherein the ending of the treating is performed when the measured specific resistance exceeds a reference value.
